(19) United States
(12) Patent Application Publication
(10) Pub. No.: US 2010/0118409 A1
(43) Pub. Date: May 13, 2010

(54) METHOD FOR DEPOSITION OF A POROUS ANTI-RELECTION LAYER, AND GLASS HAVING AN ANTI-REFLECTION LAYER

(75) Inventors: Inka Henz, Nieder-Olm (DE); Matthias Bockmeyer, Mainz (DE); Gabriele Roemer-Scheuermann, Ingelheim (DE); Hans-Joachim Schmitt, Ockenheim (DE); Harry Engelmann, Ingelheim (DE); Peter Zachmann, Osthofen (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: SCHOTT AG

(21) Appl. No.: 12/615,621

(22) Filed: Nov. 10, 2009

(30) Foreign Application Priority Data
Nov. 11, 2008 (DE) 102008056792.2-45

(51) Int. Cl. G02B 1/11; B05D 5/06

(52) U.S. Cl. 359/601; 427/162

(57) ABSTRACT

The present disclosure relates to a method for deposition of an anti-reflection layer, in which glass particles are embedded in a titanium oxide containing matrix that is produced by a sol-gel method.

### CROSS REFERENCE TO RELATED APPLICATIONS

This application claims benefit under 35 U.S.C. §119(a) of German Patent Application No. 10 2008 056 792.2-45, filed Nov. 11, 2008 in the German Patent Office, the entire contents of which are incorporated herein by reference.

### BACKGROUND OF THE INVENTION

1. Field of the Invention

The present disclosure relates to a method for deposition of a porous anti-reflection layer and to a glass having an anti-reflection layer. More particularly, the present disclosure relates to an anti-reflective glass for solar applications.

2. Description of Related Art

Anti-reflective glasses for solar applications are known.

In particular, it is known to apply porous anti-reflection layers. A method for deposition of porous anti-reflection layers is described in German publication DE 10 2005 007825 A1, for example. In such porous anti-reflection layers mixing of coating material and air occurs, thereby lowering the effective refractive index of the coating.

US 2007/0017567 A1 describes self-cleaning surfaces, inter alia on solar modules. The photocatalytically active components are embedded in a matrix. The layers are 200 nm in thickness. In these ranges, TiO₂ layers are visually noticeable. From 20 nm on, the layers present an own color (initially yellow, then red, blue and green), and from 5 nm on, provide reflection in the solar spectrum. Moreover, the effect of the photocatalytic materials is strongly limited due to the integration thereof in the matrix, such that only those particles which protrude from the layer at the upper surface thereof are active. The described matrix components contain organic components which are decomposed by photocatalysis. Chalking that results in such cases will probably not be noticed on the mentioned scattering layers (albedo surfaces), on solar modules, however, chalking generates refraction centers which reduce transmittance.

Furthermore, it is known to apply such porous anti-reflection layers by a sol-gel technique.

The requirements on anti-reflection layers for solar glass, in particular for photo-voltaic applications are high. The glass shall have an as high transmittance as possible in the entire visible spectrum of light as well as in near infrared. Therefore, the anti-reflection layer shall have an as low refractive index as possible.

At the same time, it is desired for the anti-reflection layer to be environmental resistant for decades. Also, there are strong requirements for abrasion resistance of such anti-reflection layers.

It has been found that conventional porous anti-reflection layers are contaminated rather easily, thereby causing a loss of transmittance. On the other hand, if the anti-reflection layers are often cleaned, this in turn may cause damages of the layer and hence may likewise cause a loss of transmittance.

As an architectural glass, glasses are known which have a titanium oxide containing coating. Due to the photocatalytic effect of titanium oxide and titanium dioxide, respectively, a self-cleaning effect of the glass occurs. Such glasses also are referred to as self-cleaning glasses.

Due to the high refractive index of titanium oxide and the related losses in transmittance, self-cleaning glasses produced by conventional methods are generally not suitable for solar applications, since performance losses result from the reflecting titanium oxide layer.

### BRIEF SUMMARY OF THE INVENTION

The present disclosure, therefore, provides a method which allows to provide a self-cleaning anti-reflection layer that ensures high transmittance.

More particularly, the present disclosure provides a self-cleaning anti-reflection layer with a low refractive index.

Further, the present disclosure provides an environmental resistant, abrasion-resistant, self-cleaning coating.

A method for deposition is provided that includes applying a porous anti-reflection layer and a glass for outdoor applications, in particular for architectural and solar applications.

Glass, for the purpose of the present invention, is defined as a substantially transparent glass, glass ceramics or transparent plastics suitable in form of a disc, such as soda-lime glass, BOROFLOAT®, solar glasses and the like, all glass ceramics, preferably transparent glass ceramics such as ROBAX®, ZERODUR® and the like, and transparent optical plastics such as polymethylmethacrylate, cycloolefinic copolymeres, polycarbonate and the like. Preferably, a flat glass is used, however, the invention is not limited to plate-like substrates.

The present disclosure relates to a method for deposition of a porous anti-reflection layer. The anti-reflection layer is deposited by a sol-gel method.

Surprisingly, it has been found that titanium oxide does not cause any significant deterioration of the optical properties of an porous anti-reflection layer.

Rather, the layers of the present disclosure have a refractive index comparable to that of other porous anti-reflection layers such as those based on silicon oxide particles and a silicon oxide matrix, and hence exhibit very good anti-reflective properties with, additionally, a photocatalytically active surface.

According to the present disclosure, a titanium containing precursor is used, and particles are added to the sol-gel solution, especially nanoparticles, e.g. silicon oxide or silicon dioxide in form of nanoparticles.

In the method of the present disclosure the titanium containing precursor thus provokes formation of a titanium oxide containing matrix. Preferably, the matrix formed by hydrolysis and condensation is primarily made up of amorphous titanium oxide with an amount of residual organics of 10-50%, after thermal treatment. The residual organics are removed by a thermal treatment, and a matrix of cristalline or partially cristalline TiO₂ is formed, preferably in the anatase modification. The crystallite size of nano-scale cristalline or partially cristalline TiO₂ preferably ranges between 4 and 35 nm, more preferably between 8 and 25 nm. The matrix has nanoparticles embedded therein, in particular silicon oxide containing nanoparticles. The matrix-forming titanium oxide preferably has a micro- or meso-porosity of 1-25%.

Synthesis routing according to the present disclosure is achieved by the fact that the matrix-forming TiO₂ only forms between and/or on SiO₂ particles. In this manner, a large accessible surface of photocatalytically active TiO₂ is obtained, with at the same time a small mass fraction and volume fraction, respectively, of TiO₂ in the layer. In this manner it is achieved that notwithstanding the high refractive index of TiO₂ the refractive index of the amorphous-cristalline composite layer is low.

It has been found that for example unlike in methods in which titanium dioxide is added in particle form, in particular in form of cristalline nanoparticles, the optical properties of layers produced by the method of the present disclosure do not significantly change in comparison to a coating produced by a silicon containing precursor.

Thus, the method of the present disclosure allows to produce an anti-reflection layer having a refractive index of less than 1.38, preferably less than 1.34, and most preferably less than 1.30.

Preferably, the anti reflection layer is embodied as a single layer anti-reflection layer, which has, in contrary to interference-layer-systems, reflective properties due to its refractive index and which does not increase the reflection of the composite material at any wavelength. The anti-reflection layer is embodied as a wide band anti-reflection layer.

In a preferred embodiment of the present disclosure the particles, in particular nanoparticles, have a refractive index smaller than or equal to 1.7, preferably smaller than or equal to 1.6 and most preferably smaller than or equal to 1.55.

Therefore, a glass provided with an anti-reflection layer according to the present disclosure has a high transmittance. In particular, a glass can be provided which has a transmittance of at least 85%, preferably of at least 90% and most preferably of at least 95% in the entire range of wavelengths between 450 and 800 nm.

It has further been found that already a relatively small amount of titanium oxide in the whole layer, in particular less than 40, preferably less than 20 and most preferably less than 15 wt-%, is sufficient for an adequate self-cleaning effect.

In particular a sol-gel solution is used in which the proportion of particles to precursor is between 0.1 and 0.9, preferably 0.7 to 0.8, the proportion being calculated based on wt-%.

In particular, the present disclosure provides a glass in which the added particles comprise at least 60, preferably at least 70 and most preferably at least 80 wt-% of the final anti-reflection layer.

In particular the present disclosure provides a glass in which the anti-reflection layer of the present disclosure has a porosity (open porosity) between 20 and 40 vol-%. Since the pores are filled with air, the desired refractive index is obtained.

Nanoparticles of a size between 1 and 100 nm, preferably 3 and 70 nanometers, most preferably in the range of 6-30 nm has revealed particularly suitable.

Preferably, the particles are formed from glass, glass ceramics or ceramics. With such nanoparticles, highly transparent layers can be obtained.

In a modification of the present disclosure the coating solution may contain nano-scale particles of different sizes, preferably SiO₂ particles. In particular it is considered to add particles in at least two different size fractions. Also, silicon alkoxides of a sum formula Si(OR)₄, RSi(OR)₃ (R=methyl, ethyl, phenyl) can be a component of the coating solution.

The precursor can comprise for example a titanium halogenide, a titanium nitrate, a titanium sulfate and/or a tetraalkyltitanate (titanium tetraalkoxide). In particular, titanium tetraethylate and titanium tetrapropylate are contemplated as a precursor.

In a preferred embodiment of the present disclosure a hydrolysis-stabilized titanium containing precursor is used to allow to stably keep the amorphous titanium containing TiO₂ precursor in solution in combination with an aqueous dispersion of nanocolloidal disperse SiO₂ particles.

Therefore, in sol synthesis first the titanium precursor is reacted with a complex ligand. For example, ethylacetoacetate, 2,4-pentanedione (acetylacetone), 3,5-heptanedione, 4,6-nonanedione or 3-methyl-2,4-pentanedione (2-methylacetylacetone), triethanolamine, diethanolamine, ethanolamine, 1,3-propanediole, 1,5-pentanediole, carboxylic acids such as acetic acid, propionic acid, ethoxyacetic acid, methoxyacetic acid, polyether carboxylic acids (e.g. ethoxyethoxyacetic acid) citric acid, lactic acid, methacrylic acid, acrylic acid are used as complex ligands.

The molar ratio of the complex ligand to the titanium precursor, here, preferably is 5-0.1, more preferably 2-0.6, most preferably 1.2-0.8.

The particles are not limited in its distribution of particle size. To obtain an optimal particle distribution, a preferred embodiment uses mixtures of particles of different sizes. Particularly preferred are mixtures in which a smaller particle distribution fills the gaps of a larger one.

According to preferred embodiment of the present disclosure, the anti-reflection layer comprises micro- or mesomorphous pores, in particular pores with an average diameter of 1 to 12 nm, preferably 3 to 8 nm. The diameter of the pores can determined, for example, with the method of the ellipsometric porosimetry, which is known for someone skilled in the art, and wherein H₂O is used as solvent for absorption. By using this method, the change of the refractive index of a layer is determined dependent upon the relative humidity of air. For the determination of the diameter of the pores, the adsorption isothermal line is used, and the evaluation is made according to a modified Kelvin-equitation, which is also known for someone skilled in the art. Preferably, the pores are embodied as bottleneck-like pores. According to a further embodiment, the pores can also be formed as rod shaped pores.

In a preferred embodiment of the present disclosure the titanium containing precursor comprises a hydrolysis-stabilized, water-soluble, amorphous titanium complex of titanium halogenides, titanium nitrates, titanium sulfates and/or tetraalkyltitanate, in particular titanium tetraethylate and titanium propylate.

After reaction with the complex ligand a targeted hydrolysis may be performed to obtain a better hydrolysis stability of the titanium precursor.

Preferably, the particles are of inorganic material which is in amorphous or cristalline or partially cristalline form. The particles are not limited as to its shape, for example it can be of spherical, plate-like, cylindrical, fiber-like, angular, cubic or any other conceivable form.

The molar ratio of water to the titanium precursor is 10-0.1, more preferably 7-3, most preferably 6-4. In a particular embodiment hydrolysis can be carried out under acid conditions. For this, preferably, e.g. mineral acids such as HNO₃, HCl, H₂SO₄ or organic acids such as ethoxyacetic acid, methoxyacetic acid, polyether carboxylic acids (e.g. ethoxyethoxyacetic acid) citric acid, para-toluenesulfonic acid, lactic acid, methacrylic acid, acrylic acid are added to the water for hydrolysis.

In a preferred embodiment, the solvent of the reaction mixture is removed under reduced pressure after reaction of the titanium precursor with the complex ligand and subsequent hydrolysis. A hydrolysis-stable precursor powder is obtained which is redissolvable in polar (H₂O, ethanol, n-propanol) and nonpolar (toluol) solvents.

Another way to remove the solvent to obtain a redissolvable titanium oxide precursor powder is by spray drying the reaction mixture.

The amorphous water soluble precursor powders that are used may contain dopants in an amount of <10 mol %, relative to transition metal oxides. The dopants may be added prior to or following the reaction of the titanium alkoholate with the polar complex-forming and chelating compound. Examples for suitable dopants are Fe, Mo, Ru, Os, Re, V, Rh, Nd, Pd, Pt, Sn, W, Sb, Ag and Co. These may be added to the synthesis preparation or the medium in form of its salts with corresponding stoichiometry.

In a preferred embodiment, the sol-gel solution is applied by a dip method or by roll coating. Moreover, all other conventional deposition methods for liquid coating are applicable such as e.g. spin-coating, spraying, slot-casting, flooding and painting.

The dip method is particularly useful for a uniform both-sided coating of large glass substrates.

The advantage of the roll coating method in comparison to the dip method is that coating can be carried out inline in a single apparatus on one or both sides and it is not necessary to provide large basins. Additionally, coating in this case is performed very quickly allowing for high throughputs.

In a preferred embodiment of the present disclosure the anti-reflection layer is fired or sintered at a temperature between 300 and 1000° C., preferably between 450 and 700° C., most preferably between 500 and 700° C. Thereby, organic components formed from the sol preferably are largely removed.

The obtained layer primarily contains particles, such as silicon oxide particles, which are embedded in a matrix which comprises, at least partially, cristalline titanium oxide.

The step of firing can particularly be performed during a pre-stressing process, as according to another preferred embodiment of the present disclosure, or by firing directly preceding the pre-stressing process.

Hence, firing of the anti-reflection layer requires no additional process step and as such cannot entrain a reduction of pre-stress of an already pre-stressed glass during subsequent firing of an anti-reflection layer. An advantage thereof is that the layer deposited by a sol-gel method already has a sufficient strength for further processing.

To this end, it is also conceivable to subject the coating in a first step to a thermal annealing at a lower temperature, at which the layer is not yet heated to such a high temperature at which the majority of organic components is removed. In this way, in intermediate product is produced which is suitable for pre-stressing and has a mechanically resistant anti-reflection layer.

The particles preferably are added to the sol-gel coating solution in form of a suspension.

In a modification of the present disclosure SiO₂ particles are produced by the Stöber process. Here, the particles can be either compact, microporous or mesoporous. The morphology of the particles can either be of spherical or of irregular nature.

In a particular embodiment of the coating solution, aluminum can be added in form of alkoxides, aluminum salts, complexes of alkoxides with ethylacetate or AlOOH, to improve the abrasion resistance of the layers. For instance, ethyl aceto-acetate, 2,4-pentanedione (acetylacetone), 3,5-heptanedion, 4,6-nonanedion or 3-methyl-2,4-pentanedion (2-methylacetylacetone), triethanolamine, diethanolamine, ethanolamine, 1,3-propanediol, 1,5-pentanediol, carboxylic acids like acetic acid, propionic acid, ethoxyacetic acid, methoxyacetic acid, polyether carboxylic acids (e.g. ethoxyethoxyacetic acid), citric acid, lactic acid, methacrylic acid, acrylic acid are used as complex ligands.

In a modification of the present disclosure, besides the silicon and aluminum containing oxides, mentioned above, the titanium containing matrix can comprise other semimetal or metal oxides, such as e.g. boron oxide, zirconium oxide, cerium oxide, and zinc compounds.

In a modification of the present disclosure, the combination of the nanoparticle component with the matrix-forming titanium precursor is performed in an acid environment, in particular at a pH below 3, preferably below 2.5, and more preferably below 1.5.

It has been found that the combination of matrix-forming titanium precursors and nano-colloidal disperse nanoparticles such as SiO₂ particles results in abrasion resistant layers with improved adherence, following firing.

In a modification of the present disclosure an anti-corrosion layer is deposited between the substrate and the anti-reflective layer, for reducing or eliminating corrosion of the glass, i.e. a layer which prevents direct contact of water and H⁺ ions with alkalis of the substrate glass.

Hence, initially a first layer is applied on a substrate, in particular a glass substrate, and then an anti-reflection layer is deposited thereon.

It has been found that water may cause elution in the porous anti-reflection layer, in particular in soda-lime glasses employed in architectural and solar applications. Elution of alkali ions, in particular sodium, results in glass corrosion causing haze of the glass, decomposition of the glass matrix and breaking of the anti-reflection layer.

The inventors have found that such glass corrosion processes can effectively be prevented by an intermediate layer, which either prevents water from coming into contact with the substrate glass or prevents alkali ions, in particular sodium ions, from diffusing from the glass into the anti-reflection layer.

This barrier layer and the concomitant inhibition of ion diffusion further prevents an adverse effect on the photocatalytic activity caused by ion diffusion processes from glass into TiO₂. The anti-corrosion layer allows the combination of a self-cleaning layer, based on the photo-catalytic effect of TiO₂, on soda-lime glass.

The anti-corrosion layer may for example be applied as a dense silicon oxide layer.

Various methods are suitable for applying the anti-corrosion layer, in particular the layer can be applied by flame pyrolysis or can be deposited by a PVD or CVD method. Also, it has turned out suitable to use a dense sol-gel layer. It is of particular advantage here to use a dense silicon-titanium-oxide mixing layer with approximately the same refractive index as that of the glass substrate. For example, it can be realized rather thick without affecting the optical properties of the overlying anti-reflection layer. That is why the anti-corrosion and the barrier effect is particularly pronounced in this case.

A further way to provide an anti-corrosion layer is to elute the substrate glass such as by a plasma treatment by which the alkali and/or earth alkali components in the surface area can be removed with a rather good selectivity.

A good anti-corrosion effect in the sense of the present disclosure is if the diffusion of alkalis according to the DIN 52296 assay or of water is reduced by at least 30%, preferably by 50%, more preferably 75%.

The present disclosure further relates to a glass, in particular for outdoor applications, in particular a glass for solar applications.

The glass is preferably produced by a method according to the present disclosure, it comprises a glass substrate and a titanium oxide containing porous anti-reflection layer deposited on the glass substrate by a sol-gel method.

In particular, the glass comprises a layer in which particles, in particular nanoparticles, for example silicon oxide particles, are embedded in a matrix which comprises titanium oxide formed by a sol-gel process, and which in particular is substantially made up of titanium oxide.

Preferably, the anti-reflection layer comprises silicon oxide particles with a size between 1 and 100 nm, preferably 3 and 70 nanometers, most preferably in a range of 6-30 nanometers.

Preferably, the particles comprise at least 50, more preferably at least 70 wt-% of silicon oxide. Particles which are primarily made up of silicon oxide allow to obtain low refractive indices. Furthermore, silicon oxide is particularly resistant against chemical attacks and environmental influences.

Preferably, an alkali glass is used as a glass substrate, in particular a soda-lime glass. Such glasses are inexpensive and have a high transparency. In a particular embodiment, an UV absorbing solar glass low in iron is employed.

The glass of the present disclosure is particularly suitable for outdoor applications as part of a housing for a solar module, a solar receiver or as a front panel, and for architectural glass.

It has been found that under the influence of UV radiation the layers of the present disclosure exhibit a self-cleaning effect. This self-cleaning effect is attributable to the photo-catalytic activity of TiO₂ in the anatase modification.

In a particular embodiment, of the present disclosure the photo-catalytic activity of TiO₂ is already detectable under illumination of light in the visible range of wavelengths.

In a preferred embodiment the anti-reflection layer is applied on a glass tube, which is a component part of a photovoltaic module, in particular a part of a CIGS based photovoltaic module. The anti-reflective layer preferably also has self-cleaning properties. Such a photovoltaic module may, for example, be constructed as follows, from the interior outwards: In the centre there is a solution or an oil adapted in refractive index (immersion solution or oil), followed by the inner tube of glass which is preferably made of soda-lime glass or other sodium containing glasses. The thermal expansion of the inner tube is matched with that of the absorber layer of the solar layer system, in this case a CIGS layer, and is between 7.5*10⁻⁶ K⁻¹ and 11*10⁻⁶ K⁻¹, preferably between 8.5*10⁻⁶ K⁻¹ and 10*10⁻⁶ K⁻¹.

The solar layer system can be designed as follows, from the interior outwards: inner tube/barrier (SiN; optionally)/molybdenum/absorber layer (CIGS)/buffering layer (CdS)/window layer (ZnO). In a preferred exemplary embodiment, the entire layer structure has a thickness between 3 and 4 μm. The outermost layer is separated from a polymeric tube, preferably an acrylic tube, due to the high transmittance, by the immersion solution or oil described above, which tube, again, is separated from the outer tube by the immersion solution or oil. The outer tube is made of glass and preferably has a similar thermal expansion coefficient as the inner tube. However, any glass that has a sufficiently high transmittance is contemplated, wherein soda-lime, aluminosilicate and borofloat glasses are preferred. The outer surface of the glass tube is provided with the self-cleaning anti-reflective layer. In a particular embodiment, an anti-corrosion layer is applied, in particular deposited, below the self-cleaning anti-reflective layer.

In another embodiment, the self-cleaning anti-reflection layer is applied on a planar CIGS photovoltaic module.

The preferably self-cleaning anti-reflection layer can be applied at any solar application and is not limited in terms of solar absorber layers and systems.

The glass of the present disclosure, in particular for solar applications, preferably comprises a flat glass substrate or a tubular substrate and a titanium dioxide containing porous anti-reflection layer deposited by a sol-gel method. However, the present disclosure is basically not limited to any shape of glass substrate to be coated, i.e. glass substrates of any form can be coated.

For producing the layer systems according to the present disclosure, the following general synthesis route was used in an exemplary embodiment:

110 g of ethanol with 50 g HNO₃ (1 mol/l) were provided with X g of an aqueous dispersion of nano-scale SiO₂ particles (components X and Y are defined in the following table). Y g of an amorphous hydrolysis-stabilized titanium oxide precursor dissolved in 40 g of ethanol were added to this solution. Coating solutions according to the present disclosure produced in this manner allow to produce layers according to the present disclosure by the dip coating method, at a traction speed of 10-20 cm/min, with a relative humidity of 30% and a firing temperature of 450° C.-700° C.

Amorphous hydrolysis-stabilized titanium oxide precursors were prepared according to the following syntheses:

### Precursor A:

Here, for example 1.0 mol of acetylacetone is dropped into 1.0 mol of titanium(IV) ethylate solution, while stirring for about 25 minutes, initiating considerable heating. The lemon yellow solution is stirred for 45 min at room temperature and is then hydrolyzed with 5 mol of water. The solvent and other volatile components are removed in vacuum at 80° C. and 40 mbar. Subsequently, the powder is dried for 4 hours at 125° C. A fine yellow precursor powder with an amount in oxide of about 56 wt-% is obtained.

### Precursor B:

Here, for example 1.2 mol of ethoxyacetic acid is dropped into 1.0 mol titanium(IV) propylate solution, while stirring for about 25 minutes which initiated considerable heating. The lemon yellow solution is stirred for 45 min at room temperature and is then hydrolyzed with 5 mol of water. The solvent and other volatile components are removed in vacuum at 80° C. and 40 mbar. A gel with an amount in oxide of about 50 wt-% is obtained.

An overview of the embodiments according to the present disclosure is presented in the following table:

| | | Y (titanium |
|---|---|---|
| | | oxide |
| Sol variant | X (nanoparticle component) | precursor) |
| I | 125 g, 30% aqueous | A - 4.1 g |
| | dispersion of 8 nm sized SiO₂ | |
| | particles | |
| II | 100 g, 30% aqueous | A - 4.5 g |
| | dispersion of 8 nm sized SiO₂ | |
| | particles | |
| | 15 g, 50% aqueous dispersion | |
| | of 55 nm sized SiO₂ particles | |
| III | 125 g, 30% aqueous | A - 4.5 g |
| | dispersion of 15 nm sized | |
| | SiO₂ particles | |
| IV | 125 g, aqueous dispersion of | B - 6.1 g |
| | 8 nm sized SiO₂ particles | |
| V | 125 g, 30% aqueous | B - 7.3 g |
| | dispersion of 15 nm sized | |
| | SiO₂ particles | |

The self-cleaning effect has been tested as follows:

The assays were carried out, inter alia, based on the DIN concept “DIN 52980 Photocatalytic activity of surfaces” as manual assays.

Accordingly, 3 solutions with different concentrations of methylene blue (2×10⁻³ mol/l, 2×10⁻⁴ mol/l, 2×10⁻⁵ mol/l) were prepared, by dissolving 64 mg, 6.4 mg and 0.64 mg of methylene blue in 100 ml of H₂O.

props were applied to the substrates to be measured, and decolorization under irradiation in a Suntest CPS, UV exposure up to 270 nm, 250-460 W/m², was evaluated. The results of the photocatalytically active decomposition of 10⁻⁴ mol/l of methylene blue are illustrated in the following table 1. It has been found that the sample according to the present disclosure exhibits significant improvements in comparison to reference substrates and also to commercially available photocatalytically active self-cleaning glass.

TABLE 1
Decolorization of 10⁻⁴ mol/l of methylene blue
in the assay described above

| | | | Commercially | |
|---|---|---|---|---|
| | | | available | |
| | | Reference-porous | photocatalytically | |
| exposure | | single-layer | active | |
| time | reference | Anti-reflection | architectural | sample |
| [h] | (uncoated) | coating | glass | IV |
| 0.5 | 5 | 5 | 4 | 4 |
| 1 | 4 | 5 | 3 | 3 |
| 1.5 | 4 | 4 | 3 | 2 |
| 2 | 4 | 4 | 3 | 1 |
| 2.5 | 4 | 4 | 3 | 0 |
| 3 | 3 | 4 | 3 | 0 |
| 3.5 | 3 | 4 | 3 | 0 |
| 4 | 3 | 4 | 3 | 0 |

key:
0 = no residual noticeable
1 = residual only very faintly noticeable
2 = residual only faintly noticeable
3 = residual still visible
4 = residual still considerably visible
5 = no change, all residual still visible

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

The present disclosure will now be described in detail with reference to the drawings.

FIG. 1 schematically shows an exemplary embodiment of a glass according to the present disclosure, and

FIG. 2 schematically shows a detailed view of an anti-reflection layer.

### DETAILED DESCRIPTION OF THE INVENTION

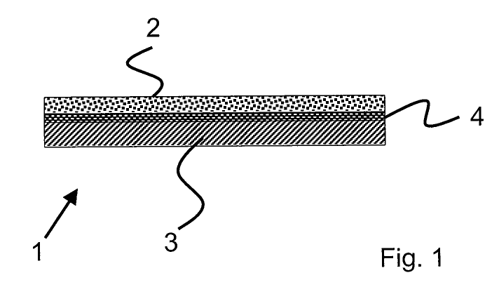

FIG. 1 schematically illustrates a glass 1 which comprises a glass substrate 3 and a titanium oxide containing anti-reflection layer 2 deposited by a sol-gel method.

Anti-reflection layer 2, in this exemplary embodiment, has an amount of titanium dioxide between 5 and 20% and therefore is self-cleaning, due to the photocatalytic effect of titanium oxide. The refractive index is less than 1.34.

Between anti-reflection layer 2 and glass substrate 3, in this exemplary embodiment, a dense anti-corrosion layer 4 is arranged which is deposited by flame pyrolysis, which prevents water from coming into contact with the glass substrate 3 in the porous anti-reflection layer 2 and thus to cause glass corrosion in glass substrate 3.

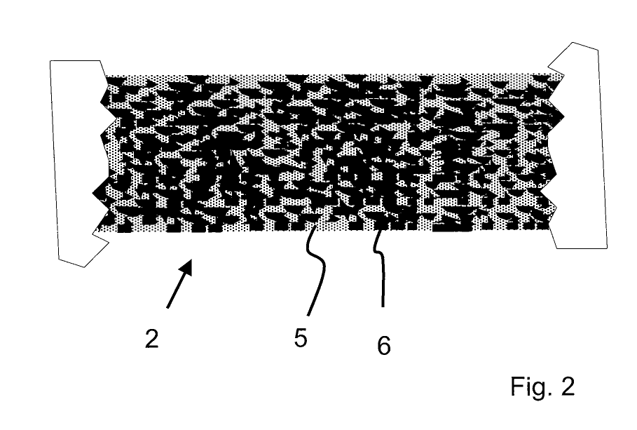

FIG. 2 schematically shows a detailed view of an anti-reflection layer 2. Anti-reflection layer 2 comprises a matrix 5 of titanium dioxide formed by a sol-gel method, with particles of silicon oxide 6 embedded therein.

The anti-reflection layer, e.g., can be produced as follows:

For example, 0.1 mol of acetylacetonate is dropped into 0.1 mol of titanium(IV) butylate solution, under stirring. Then, after dropwise adding 0.3 mol of H₂O, the solution is stirred (1 h) and 10 g of 1,5-pentanediol is added.

Subsequently, 48 g of a 30 wt-% alcoholic dispersion of SiO₂ nanoparticles in isopropanol having a mean sphere diameter from 10 to 15 nm is added to this solution, while stirring.

Further, 192 g of a 30 wt-% alcoholic dispersion of SiO₂ nanoparticles in isopropanol having a mean sphere diameter from 18 to 30 nm is added under stirring. The SiO₂ particles used have a substantially spherical geometry. Subsequently, the solution is diluted with 2400 g of ethanol.

With the solution produced in this manner mechanically resistant anti-reflection layers can be produced by the dip coating method, at a traction speed of 10-30 cm/min, with a relative humidity of <40% and a firing temperature of 450° C.-700° C.

According to another embodiment, the anti-reflection layer can be produced as follows:

For example, 0.1 mol of acetylacetonate is dropped into 0.1 mol of titanium(IV) butylate solution, while stirring. Then, after dropwise adding 0.3 mol of H₂O, the solution is stirred (1 h), and 10 g of 1,5-pentanediol is added. Subsequently, 480 g of a 15 wt-% alcoholic dispersion of SiO₂ nanoparticles in isopropanol is added to this solution, while stirring. The particles used have an elongated fiber-like geometry with a mean diameter of 10-15 nm and a length of 30-150 nm. Subsequently, the solution is diluted with 2160 g of ethanol.

With the solution produced in this manner layers according to the present disclosure can be produced by the dip coating method, at a traction speed of 10-30 cm/min, with a relative humidity of <40% and a firing temperature of 450° C.-700° C.

The present disclosure provides a weather resistant, self-cleaning glass which is particularly useful for solar applications.

It will be understood that the present disclosure is not limited to a combination of the features described above, rather, a person skilled in the art may combine any features, as appropriate.

What is claimed is:

1. A method for deposition of a porous anti-reflection layer, comprising:
depositing the porous anti-reflection layer by a sol-gel method using a sol-gel solution comprising a titanium containing precursor and nanoparticles particles.

2. The method according to claim 1, wherein the nanoparticles comprise silicon oxide in particle form.

3. The method according to claim 1, wherein the nanoparticles are present in a ratio to the titanium containing precursor in the sol-gel solution of between 0.1 and 0.9.

4. The method according to claim 3, wherein the ratio is between 0.7 and 0.8.

5. The method according to claim 1, wherein the nanoparticles are of a size between 1 and 100 nanometers.

6. The method according to claim 1, wherein the nanoparticles are of a size between 3 and 70 nanometers.

7. The method according to claim 1, wherein the nanoparticles are of a size between 6 to 30 nanometers.

8. The method according to claim 1, further comprising firing the sol-gel solution at a temperature between 300° C. and 1000° C.

9. The method according to claim 8, wherein the temperature is between 500° C. and 700° C.

10. The method according to claim 1, wherein the depositing step further comprises:
depositing the porous anti-reflection layer on a glass substrate, the glass substrate being in a pre-stressed condition due to firing of the sol gel solution.

11. The method according claim 1, further comprising adding the nanoparticles to the sol gel solution in the form of a suspension.

12. The method according to claim 1, wherein the titanium containing precursor comprises titanium oxide in a matrix.

13. The method according to claim 12, wherein the titanium oxide comprises nanocristalline, photocatalytically active TiO₂.

14. The method according to claim 10, further comprising depositing an anti-corrosion layer between the glass substrate and the porous anti-reflection layer.

15. A glass for solar applications, comprising:
a glass substrate; and
a titanium oxide containing porous anti-reflection layer deposited on the glass substrate by a sol-gel method.

16. The glass according to claim 15, wherein the porous anti-reflection layer comprises titanium oxide at least partially formed by a sol-gel process and silicon oxide nanoparticles.

17. The glass according to claim 16, wherein the porous anti-reflection layer comprises between 30 and 95 wt-% of the silicon oxide nanoparticles.

18. The glass according to claim 15, further comprising an anti-corrosion layer arranged between the glass substrate and the porous anti-reflection layer.

19. The glass according to claim 15, wherein the titanium oxide is less than 40 wt-%.

20. The glass according to claim 15, wherein the porous anti-reflection layer has a refractive index of less than 1.38.
